(19) United States
(12) Patent Application Publication
(10) Pub. No.: US 2010/0272510 A1
(43) Pub. Date: Oct. 28, 2010

(54) Illuminated groove seals for pathways

(75) Inventor: Kam Mohajer, Edwards, CO (US)

Correspondence Address: Elizabeth R. Hall;Elizabeth R. Hall & Associates, P.C., P.O. Box 66629, HOUSTON, TX, 77266-6629, US

(73) Assignee: LED Lane Light Inc., Edwards, CO (US)

(21) Appl. No.: 12/658,146

(22) Filed: Feb. 3, 2010

Related U.S. Application Data
(60) Provisional application No. 61/214,527, filed on Apr. 24, 2009.

(51) Int. Cl. E01F 9/06; F21S 4/00; F21L 4/02

(52) U.S. Cl. 404/13; 362/249.02; 362/184

(57) ABSTRACT

A smart groove seal integrating a communication system within a groove seal used to seal expansion joints and grooves formed in pathways or roadways. One embodiment of the smart groove seal embeds one or more illumination sources that emits visible and/or infrared light into a clear elastomeric expansion joint seal. The communication system includes an expansion joint seal having a selectable array on one or more light sources (such as LEDs and/or OLEDs) positioned within the expansion joint seal, a power supply, and a controller. The smart groove seal enhances the lighting of lanes on vehicular and pedestrian roadways and/or provides vehicular or roadway information to vehicular operators.

### CROSS REFERENCE TO RELATED APPLICATIONS

This application claims priority to pending U.S. Patent Application Ser. No. 61/214,527 (Attorney Docket Number KAM-P002V1), filed Apr. 24, 2009 by inventor Kim Mohajer and entitled “Apparatus and Method for Identifying Traffic Lanes and Their Parameters.”

### BACKGROUND OF THE INVENTION

1. Field of the Invention

The present invention relates to an illuminated elongated groove seal for vehicular and/or pedestrian roadways. More specifically, the present invention relates to a roadway groove seal having a plurality of light sources such as visible or infrared light emitters positioned along the length of the groove seal.

2. Description of the Related Art

Roadways, highway lanes, airport runways, airport taxi ways, and airport terminals and aprons, hospitals, warehouses, manufacturing facilities, shopping malls, amusement parks, and major sports facilities have been identified and their pathways separated by paint stripes, reflective paint stripes, optical reflectors, knobs, rumble stripes, noise generating surfaces, and other similar means.

Current methods that rely primarily on such reflective or acoustic apparatus, however, are not very successful in providing early and adequate warning to operators to enable them to take timely action to avoid dangerous conditions.

There is an ongoing need to provide roadway instructions to pedestrians and vehicular operators that is clearly communicated under all conditions. For example, there is a need to provide improved lane identification including enhanced visibility of lane markers in all weather conditions that provide earlier warning of changing and/or dangerous conditions and thereby reduce accidents, reduce operator stress, and increase the traffic flow capacity.

### SUMMARY OF THE INVENTION

Embodiments of the present invention include a communication system having an illuminated elongated roadway groove seal. The communication system includes a groove seal having a selectable array of one or more light sources (such as LEDs, or OLEDs) positioned within the groove seal, a power supply, and a controller. The smart groove seal enhances the lighting of lanes on vehicular and pedestrian roadways and/or provides vehicular or roadway information to vehicular operators or pedestrians.

One embodiment of the present invention includes a selectably illuminatable pathway groove seal for insertion into a pathway surface comprising: an elongated enclosure having a first side and a second opposed side, wherein when the enclosure is emplaced in a groove formed in a pathway the first side of the enclosure sealingly abuts a first side of the groove and the second side of the enclosure sealingly abuts a second side of the groove; and a plurality of illumination sources positioned within the enclosure, wherein the illumination sources are positioned along a length of the enclosure and wherein the illumination sources are in communication with a remote programmable controller.

A second embodiment of the invention includes a selectably illuminatable roadway groove seal for insertion into a roadway surface comprising: a compressible, transparent elastomeric elongated enclosure having a first side and a second opposed side, wherein when the enclosure is emplaced in a groove formed in a roadway the first side of the enclosure sealingly abuts a first side of the groove and the second side of the enclosure sealingly abuts a second side of the groove; a plurality of visible light sources positioned within the enclosure, wherein the light sources are positioned along the length of the enclosure and wherein the light sources are in communication with a remote power supply; and a programmable controller in communication with the visible light sources, wherein the controller activates a first set of the light sources whenever a first set of conditions occur, whereby the activated light sources illuminate the roadway surface proximal to the activated light sources.

A third embodiment of the invention includes a selectably illuminatable roadway groove seal for insertion into a roadway surface comprising: an elastomeric elongated enclosure having a first side and a second opposed side, wherein when a length of the enclosure is emplaced in a groove formed in a roadway surface the first side of the enclosure sealingly abuts a first side of the groove and the second side of the enclosure sealingly abuts a second side of the groove; and a plurality of infrared transmitters positioned within the enclosure, wherein the infrared transmitters illuminate a portion of the roadway surface; whereby the portion of the roadway surface illuminated by the infrared transmitters is visualized by a vehicle equipped with an infrared sensor.

The foregoing has outlined rather broadly several aspects of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed might be readily utilized as a basis for modifying or redesigning the structures for carrying out the same purposes as the invention. It should be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a top perspective view of a prior art two-lane roadway.

FIG. 2 is a cross-sectional view of a prior art expansion joint seal embedded in an expansion joint of a roadway surface.

FIG. 3 is a cross-sectional view of a multi-chambered enclosure containing illumination sources positioned in the upper central chamber.

FIG. 4 is a cross-sectional view of an enclosure containing illumination sources mounted on the upper interior surface of the enclosure.

FIG. 5 is a cross-sectional view of an enclosure containing illumination sources attached on the upper interior surface of the enclosure.

FIG. 6 is a schematic representation of the pathway groove seal communication system.

FIG. 7A is a top perspective view of a two-lane roadway enhanced by the incorporation of one embodiment of the pathway groove seal communication system.

FIG. 7B is a cross-sectional side view taken along line 7B-7B of FIG. 7A.

FIG. 8 is a top perspective view of a two-lane roadway enhanced by the incorporation of one embodiment of the pathway groove seal communication system illustrating an illuminated turn.

It is noted that like reference characters designate like or similar parts throughout the drawings. The figures, or drawings, are not intended to be to scale. For example, purely for the sake of greater clarity in the drawings, wall thicknesses and spacings are not dimensioned as they actually exist in the assembled embodiments.

### DESCRIPTION OF THE PREFERRED EMBODIMENTS OF THE APPARATUS

One embodiment of the present invention relates to a communication system having a smart groove seal having a selectable array of illumination sources positioned within the groove seal, where the smart groove seal is used to seal expansion joints and grooves in pathways or roadways.

An “illumination source” is herein defined as a source of light such as visible light or infrared (IR) light. The definition of an illumination source includes but is not limited to light emitting diodes (LEDs) and organic light emitting diodes (OLEDs).

An “expansion joint seal” is used herein equivalently with a “groove seal” and is defined herein as an elastomeric elongated enclosure having a first side and a second opposed side, wherein when the enclosure is press fitted into a groove formed in a pathway the first side of the enclosure sealingly abuts a first side of the pathway groove and the second side of the enclosure sealingly abuts a second side of the pathway groove.

A “pathway” is used herein equivalently with a “roadway” and is defined as a path used by vehicular or pedestrian traffic. Pathways as used herein include, but are not limited to, highways, streets, airport runways, airport taxi ways, airport aprons, parking lots, parking garages, pedestrian cross-walks, warehouse aisles, loading docks and the like. Many of the pathways include traffic lanes.

The pathways are used by various vehicles (car, truck, plane, train, etc.) that are driven or operated by an operator (driver, pilot, etc.). It is understood that these terms (roadway, traffic lanes, vehicle and operator) are meant only as examples and are not intended to limit the scope of the invention.

Prior Art Roadway or Pathway Expansion Joints and Expansion Joint Seals

The majority of roadways have concrete traffic lanes (for example highways and sidewalks) but other materials such as asphalt can be used. Concrete traffic lanes are used herein by way of example but are not intended to limit the scope of the invention.

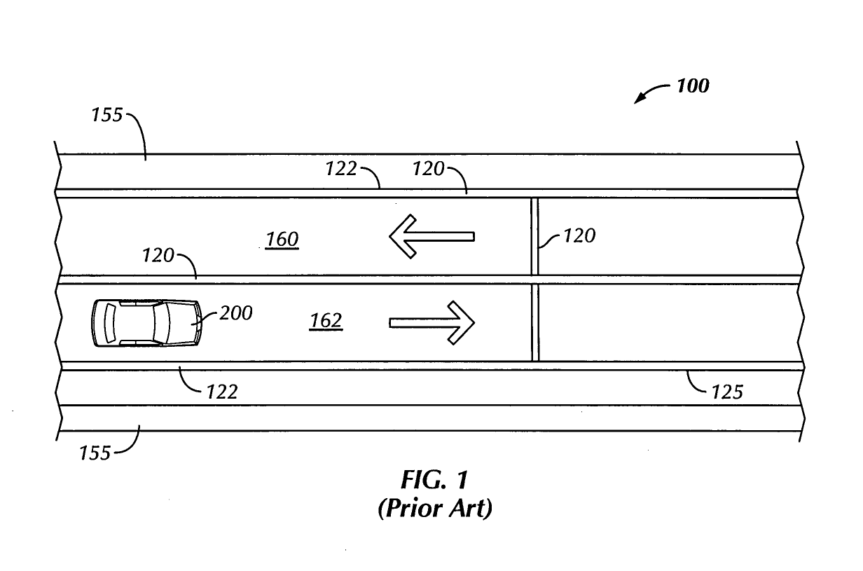

Referring now to the drawings, and initially to FIG. 1, it is pointed out that like reference characters designate like or similar parts throughout the drawings. The Figures, or drawings, are not intended to be to scale. For example, purely for the sake of greater clarity in the drawings, wall thickness and spacing are not dimensioned as they actually exist in any of the embodiments.

A section of a typical two traffic lane roadway 100 is shown in FIG. 1 in plan view. The roadway of FIG. 1 is located on the ground surface and is shown with two road shoulders 155 and two traffic lanes 160 and 162. The two traffic lanes 160 and 162 are paved, either with concrete slabs or concrete slabs with an asphalt overlay, while the shoulders 155 normally are paved with asphalt.

Since concrete traffic lanes are subject to dimensional changes caused by temperature variations, expansion joints 120 are typically provided between individual slabs in any given lane and between adjacent lanes. These expansion joints 120 also serve to limit the individual slab sizes for convenience in making pours and slab surface finishing.

In order to prevent water infiltration into the subgrade underneath the slabs the expansion joint are generally sealed. Expansion joints have been sealed with a variety of types of sealants, such as chemical based silicone sealants and elastomeric sealants.

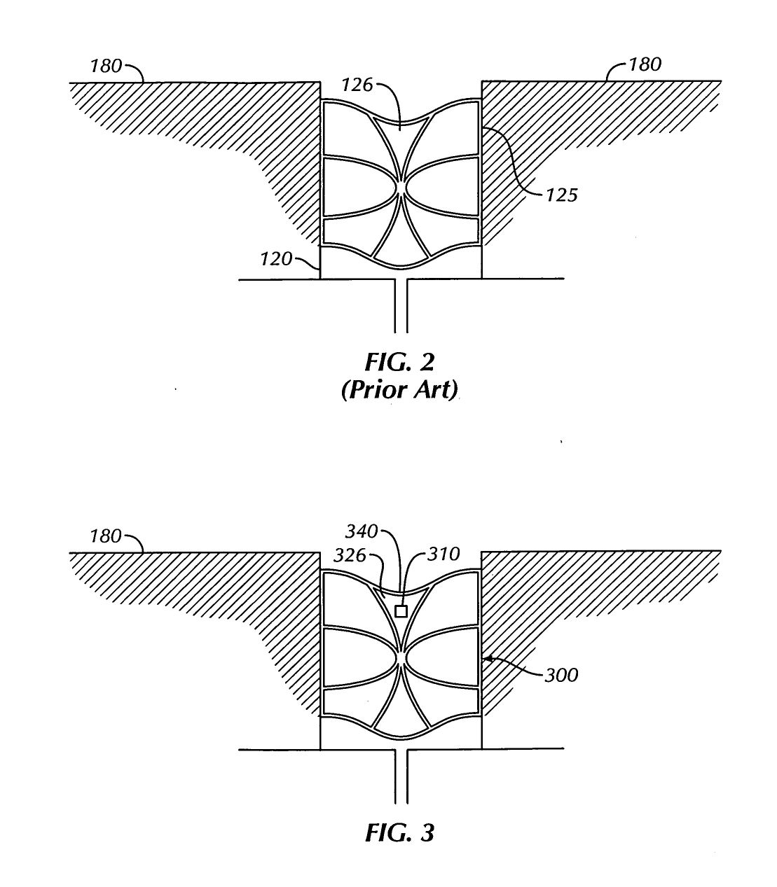

One example of a multi-chambered elastomeric sealant 125 (the Delastic® Pavement Seal manufactured by The D. S. Brown Company in North Baltimore, Ohio) is shown in cross-section in FIG. 2. The Delastic® Pavement Seal is commonly used to seal expansion joints in highways, airport aprons, and runways and it meets or exceeds the ASTM standards and all requirements of the Department of Transportation, the Highway Department, and the American Society of Civil Engineers. Useful inherent characteristics of this expansion joint seal include the ability to seal joints in concrete even when moisture is present, resistance to jet fuel and other chemicals, speed of installation, product cleanliness, ease of inspection, and a dramatic reduction in concrete joint spalling. Delastic® Pavement Seals are extruded from compounds of neoprene (polychloroprene) and include multiple chambers 126.

The expansion joint seal 125 is installed within the expansion joint 120 by compressing the seal 125 and force fitting it into the expansion joint 120. Once installed the elastomeric expansion joint seal 125 presses against the walls of the expansion joint and are sealingly abutted and biased against the adjacent walls of the expansion joint 120 maintaining a watertight seal in the expansion joint while allowing the concrete pavement 180 to expand and contract during temperature changes.

Smart Groove or Expansion Joint Seals

The present invention includes a smart groove seal (expansion joint seal) integrating an illumination source within an elongated elastomeric enclosure used to seal expansion joints and grooves in pathways or roadways. The smart groove seals typically incorporate a plurality of illumination sources along a length of the elongated enclosure. The elongated elastomeric enclosure has either multiple chambers or a single chamber.

A cross-sectional view of one embodiment of a smart groove seal 300 is schematically shown in FIG. 3. The embodiment shown in FIG. 3 includes a multi-chambered expansion joint seal like the Delastic® Pavement seal with an illumination source 310 integrated therein. The groove seal is made of an elastomeric material and the illumination source is positioned in an upper central chamber 326. One embodiment of the smart expansion joint seal 300 has at least the upper elastomeric layer 340 of the upper central chamber 326 made of a transparent elastomeric surface for visible light to shine through.

Although there are various ways of incorporating the illumination source within the expansion joint seal, one method is to assemble several light sources (such as LEDs or OLEDs) into a continuous rail and to thread the illumination rail through the groove seal. This method of positioning the illumination sources into the groove seal is illustrated in FIG. 3 showing the illumination sources positioned in chamber 326. The selected array of illumination sources assembled may be a linear array of a single type of light emitter (such as visible or IR light emitters) or a mixed array of such light emitters. Preferred embodiments of the visible or IR light emitters include LEDs and/or OLEDs.

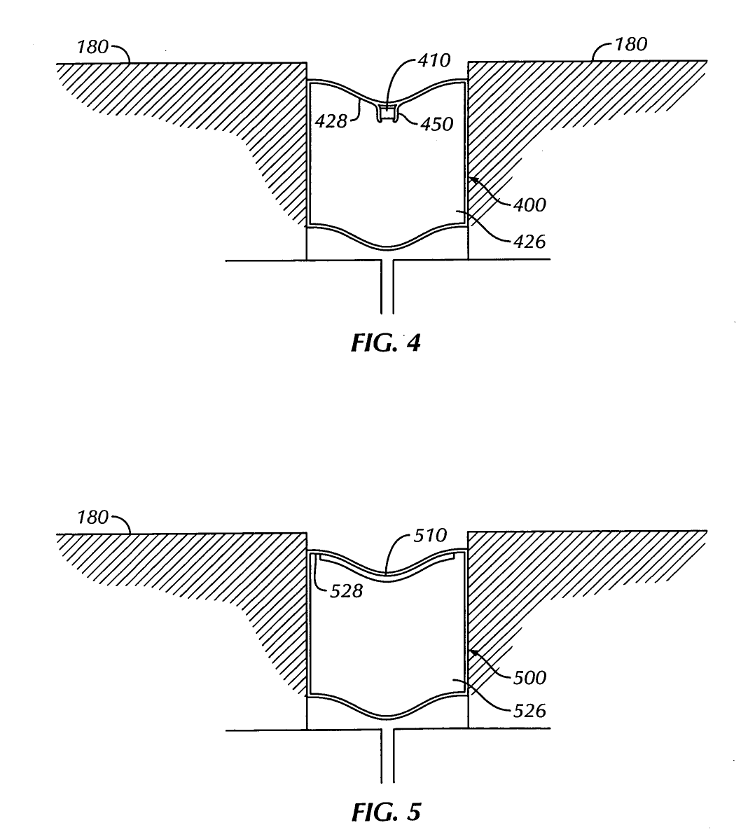

Another embodiment of the smart groove seal 400 is shown schematically in FIG. 4. The smart groove seal 400 integrates an illumination source 410 (such as LEDs or OLEDs) into a groove seal having a single chamber 426. The illumination source 410 is integrated into the expansion joint seal 400 during the manufacture of the smart expansion joint seal 400.

The illumination source 410 may be specifically positioned within the chamber 426 and attached to the upper inside surface 428 of the chamber 426 by an interference fit within elastomeric protuberances 450 of the expansion joint seal. The placement of the illumination source 410 in the smart expansion joint seal 400 by an interference fit with the elastomeric protuberances 450 allows the illumination sources to be securely positioned within the expansion joint seal chamber at particular angles. The illumination source 410 is shown schematically and may represent an array of illumination sources connected together (such as LEDs and/or OLEDs) and held in place by the placement of one or more specific illumination sources in the elastomeric protuberances 450. Selected types of light emitters and illumination sources may be assembled in one or more linear arrays or in one or more mixed arrays of different types.

Yet another embodiment of the smart groove seal 500 is shown in FIG. 5. The smart groove seal 500 integrates an illumination source 510 (such as LEDs and/or OLEDs) into an elongated elastomeric expansion joint seal. The illumination source 510 is specifically positioned within the chamber 526 and is directly attached to the upper inside surface 528 of the chamber 526 using an adhesive, or is indirectly mounted to the upper inside surface 528 of the chamber 526 using a flexible material that is adhered to the surface 528 of the chamber 526.

The embodiments of the smart groove seal shown in FIGS. 3-5 are shown by way of example and are not intended to limit the scope of the invention. When the illumination sources include visible light emitters, the elongated elastomeric enclosure is preferably manufactured of a clear elastomeric material.

The Groove or Pathway Expansion Joint Communication System

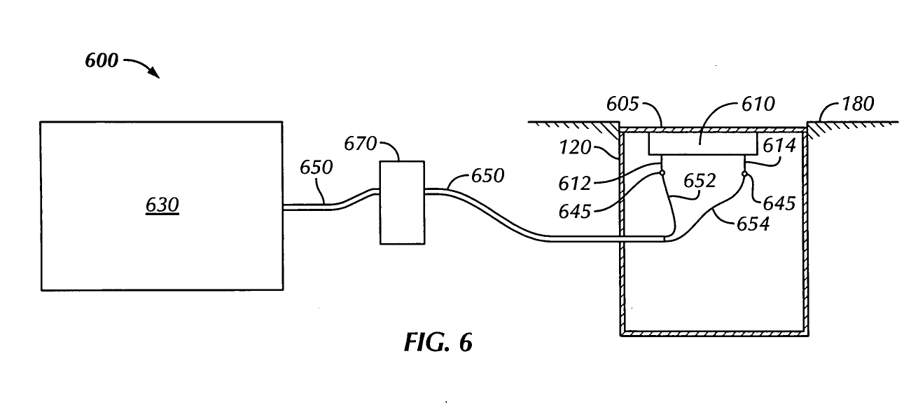

One embodiment of the pathway expansion joint communication system 600 is shown schematically in FIG. 6; however, the components of the system 600 are not intended to be dimensioned as they actually exist in the communication system 600.

The pathway expansion joint communication system 600 includes at least one smart groove seal 605 emplaced within an expansion joint 120 or groove 720, a power supply 630 for the illumination source 610 positioned within the smart groove seal 605, and a controller 670 for providing instructions for the smart groove seal and/or the power supply. The smart groove seal 605 of the pathway expansion joint communication system has a selectable array of one or more illumination sources 610 (such as LEDs and/or OLEDs) positioned within the groove seal 605 as described above. The illumination sources 610 within the groove seal 605 emit visible and/or infrared light.

Electrical power is supplied from a power supply 630 to the illumination sources 610 through wiring 650 either emplaced in preexisting conduits accessing both the expansion joint 120 and/or cut grooves 720 or by means of wiring 650 run through transverse expansion joints in the roadway. The wiring 650 connects the power supply 630 to a controller 670 and then to the illumination sources 610. The smart groove seal 605 includes a selectable array of illumination sources 610 having positive 612 and negative 614 wiring. The wiring 650 from the power supply 630 and the controller 670 contains a positive 652 wire and a negative 654 wire that are connected respectively to the positive 612 and negative 614 wiring of the illumination sources 610 through connection points 645.

The power supply for the illumination sources is preferably supplied from batteries 740 storing electrical energy collected by solar panels 735. However, other types of power supplies are known in the art. For example, power may be supplied from electrical mains.

The controller 670 serves to provide appropriate, conditioned electrical power to the illumination sources 610 and includes a programmable unit for controlling various aspects of the array of illumination sources 610 such as a pattern of activating specific designated illumination sources 610 under predetermined conditions, or of varying the operating conditions of the illumination sources 610.

First Embodiment of the Expansion Joint Communication System

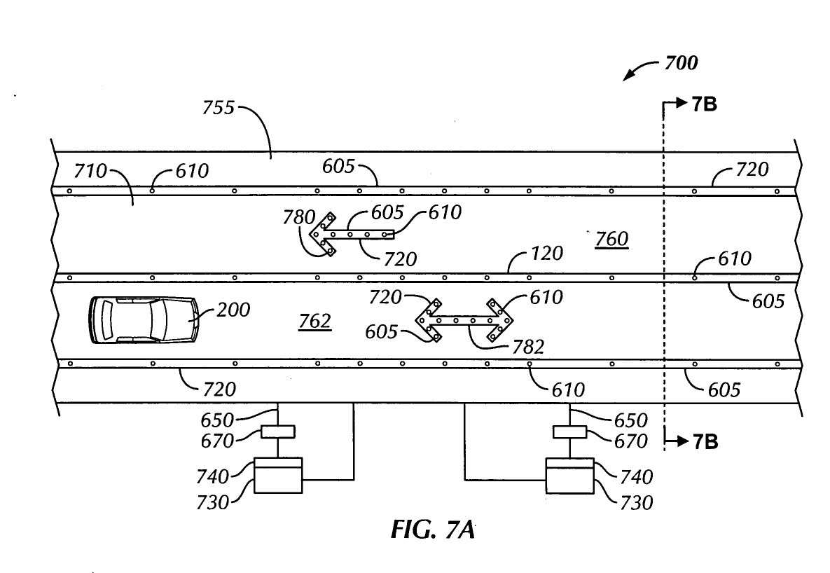

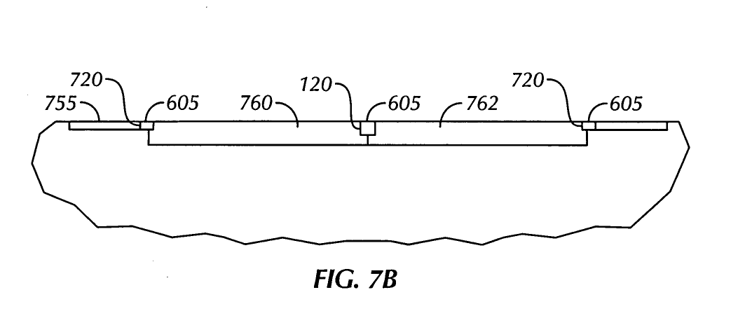

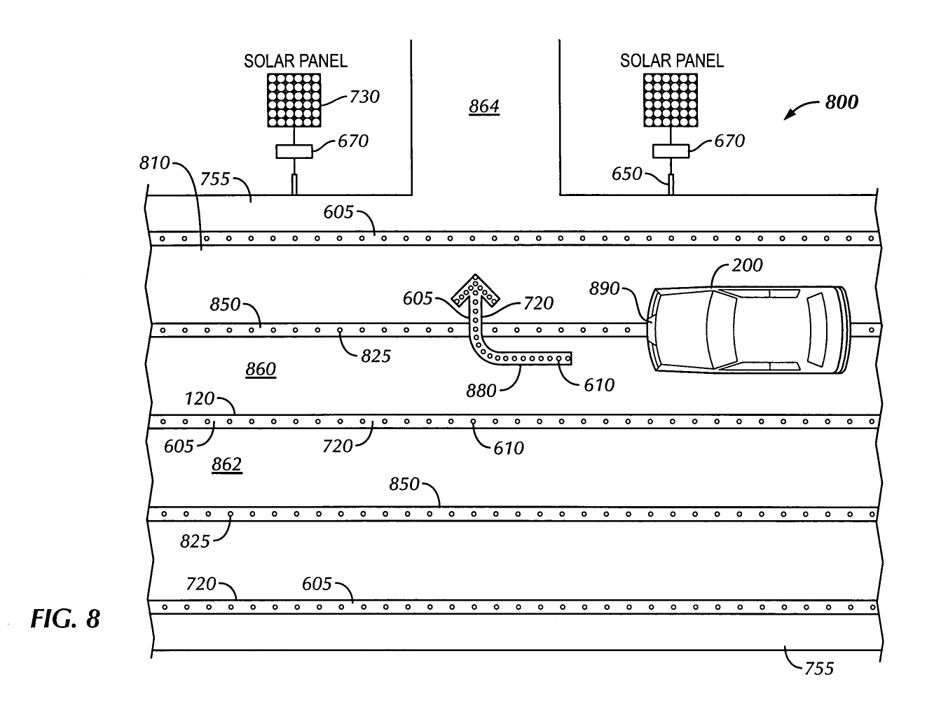

One embodiment of the expansion joint communication system 700 is shown in FIG. 7A. The pathway illustrated in FIG. 7A is a plan view of a typical two traffic lane roadway 710. The roadway of FIG. 7A is shown with two road shoulders 755 and two traffic lanes 760 and 762.

The two traffic lanes 760 and 762 are paved, either with concrete slabs or concrete slabs with an asphalt overlay, while the shoulders 755 normally are paved with asphalt. While asphalt roadways generally do not require expansion joints, the provision of expansion joints or grooved slots in the asphalt pavement can be provided without difficulty. Herein, it is assumed that purely asphalt paving may be used interchangeably with concrete and that suitable slots or grooves similar to those of concrete expansion joints may be cut or formed into the pavement surface as needed in order to house the smart groove seals 605.

As illustrated in FIG. 7B, the outer edges of the lanes 760 and 762 of the roadway 710 are each delineated by a smart groove seal 605. Any embodiment of the smart groove seal shown in FIGS. 3-5 or described above may be used.

The smart expansion joint seal 605 used to delineate the outer edges of the roadway is generally emplaced in a slot or groove 720 cut or formed in the boundary between the road shoulder 655 and its respective adjacent outer lane 760 or 762. Yet between the two traffic lanes 760 and 762, a smart groove seal 605 is compressed and force fitted into the already existing expansion joint 120.

In the smart expansion joint seal communication system 700 electrical power is supplied to the illumination sources 610 in the smart groove seal 605 by a solar panel 730 connected to an optional battery 740. This power is delivered to the smart groove seal 605 through wiring 650 emplaced in preexisting conduits accessing both the expansion joints 120 and the formed or cut grooves 720.

One aspect of the smart expansion joint seal communication system 700 shown in FIG. 7A is a first embodiment of a directional arrow 780 in the first traffic lane 760. The directional arrow 780 is formed by cutting grooves or slots 720 in the traffic lane 760 and compressing and force fitting the smart groove seal 605 into the slots 720 that form the directional arrow 780.

A second embodiment of a two-way directional arrow 782 in the second traffic lane 762 is also shown in FIG. 7A. The two-way directional arrow 782 is formed, as for the directional arrow 780, by cutting grooves or slots 720 in the traffic lane 762 and compressing and force fitting the smart groove seal 605 into the slots 720 that form the directional arrow 782.

The wiring 650 to the illumination sources 610 of the directional arrows 680 and 682 is routed through conduits placed under or through the roadway 710 accessing the cut grooves 720 and the smart groove seals 605 making up the directional arrows 780 and 782.

The controller 670 is programmed to enable or activate any of the selectable array of illumination sources 610 (e.g., visible or IR emitters). The controller may also be programmed to activate blinking variances in light color and/or variances in luminosity to account for changes in ambient light (e.g., greater luminosity during day light and less during night) and/or variances in the continuity of the emitted light (e.g., flashing lights to indicate specific safety situations such as road work, vehicle accidents, dangerous road conditions, and the like).

The controller may also be programmed to activate particular illumination sources 610 in the two-way directional arrow 782 such that ends of the arrow 784 pointing in a first direction are activated, or the ends of the arrow 786 pointing in a second direction are activated to indicate when the traffic flow within traffic lane 762 switches direction to accommodate increased vehicular traffic during rush hour(s).

Second Embodiment of the Expansion Joint Communication System

A second embodiment of the pathway expansion joint communication system 800 is shown in FIG. 8. The pathway illustrated in FIG. 8, similar to that of FIG. 7, is a plan view of a typical two traffic lane roadway 810. The roadway of FIG. 8 is shown with two road shoulders 755 and two traffic lanes 860 and 862.

The smart groove seal 605 used to delineate the outer edges of the roadway is generally emplaced in a slot 720 cut or formed in the boundary between the road shoulder 755 and its respective adjacent outer lane 860 or 862. Yet between the two traffic lanes 860 and 862, a smart groove seal 605 is compressed and force fitted into the already existing expansion joint 120.

In the smart expansion joint seal communication system 800 electrical power is supplied to the illumination sources 610 in the smart groove seal 605 by a solar panel 730. Electrical power is delivered to the smart groove seal 605 through wiring 650 either emplaced in preexisting conduits accessing both the expansion joint 120 and/or cut grooves 720 or by means of wiring 650 run through transverse expansion joints in the roadway.

One aspect of the smart expansion joint seal communication system 800 that is different from the communication system 700 shown in FIG. 7A is a directional turn arrow 880 in the first traffic lane 860. The turn arrow 880 is formed by cutting grooves or slots 720 in the traffic lane 860 and compressing and force fitting the smart groove seal 605 into the slots 720 that form the turn arrow 880.

The selectable array of illumination sources 610 (typically LEDs or OLEDs that emit visible and/or infrared light) in the smart expansion joint seal 605 of the turn arrow 880 are spaced closer together for areas where debris (such as sand, rain, muddy water, snow and ice) is likely to cover the roadway 810. The turn arrow 880 enhances the operator awareness of the intersecting traffic lane 864.

The wiring 650 to the turn arrow 880, like the wiring for the lane marking groove seals, is typically routed through conduits placed under or through the roadway 810 accessing the cut grooves 720 and the smart groove seals 605 making up the turn arrow 880.

The controller 670 is programmed to enable any of the selectable array of illumination sources 610 (typically LEDs or OLEDs that emit visible and/or infrared light). The controller may also be programmed to activate variances in luminosity to account for changes in ambient light (e.g., greater luminosity during day light and less during night) and/or variances in the continuity of the emitted light (e.g., flashing lights to indicate specific safety situations such as road work, vehicle accidents, dangerous road conditions, and the like).

Another aspect of the smart expansion joint seal communication system 800 that is different from the communication system 700 shown in FIG. 7A is the inclusion of a smart groove seal 850 centrally emplaced along a predetermined length of the first traffic lane 860 and the second traffic lane 862. Like the turn arrow 880, the centrally emplaced smart expansion seal 850 is compressed and force fitted into slots 720 formed in the traffic lanes 860 and 862.

A preferred embodiment of the illumination sources positioned in the centrally emplaced smart expansion joint seal 850 includes IR emitters 825 designed to communicate with IR receptors 890 on a vehicle 200. The infrared transmissions of the IR transmitters 825 in the smart expansion joint seal 850, although invisible to the operator, are sensed by an IR receptor 890 on a vehicle. The IR receptor 890 communicates with an automated vehicle guidance system to keep the vehicle 200 in the traffic lane or to calculate vehicle speed.

The IR transmitters 825 can also transmit additional information on the vehicle location or road conditions. For example, the IR transmitters 825 can be used with automated vehicle guidance systems such as those described in U.S. Pat. No. 5,318,143 entitled “Method and Apparatus for Lane Sensing for Automatic Vehicle Steering” and in U.S. Pat. No. 5,351,044 entitled “Vehicle Lane Position Detection System.”

The foregoing has outlined several embodiments of the pathway expansion joint communication system and its smart groove seal. However, it should be appreciated by those skilled in the art that the conception and the specific embodiment disclosed might be readily utilized as a basis for modifying or redesigning the system or method described for carrying out the same purposes as the invention. It should be realized by those skilled in the art that such equivalent constructions do not depart from the spirit and scope of the invention as set forth in the appended claims.

What is claimed is:

1. A selectably illuminatable pathway groove seal for insertion into a pathway surface comprising:
an elongated enclosure having a first side and a second opposed side, wherein when the enclosure is emplaced in a groove in a pathway the first side of the enclosure sealingly abuts a first side of the groove and the second side of the enclosure sealingly abuts a second side of the groove; and
a plurality of illumination sources positioned within the enclosure, wherein the illumination sources are positioned along a length of the enclosure and wherein the illumination sources are in communication with a remote programmable controller.

2. The pathway groove seal of claim 1, wherein the enclosure has a polygonal cross-section that is substantially similar along the length of the enclosure.

3. The pathway groove seal of claim 1, wherein the enclosure is made of a compressible and transparent elastomer.

4. The pathway groove seal of claim 1, wherein the plurality of illumination sources includes at least one visible light source mounted on an interior surface of the enclosure.

5. The pathway groove seal of claim 1, wherein the illumination sources include LEDs or OLEDs.

6. The pathway groove seal of claim 1, wherein the illumination sources include at least one infrared transmitter.

7. The pathway groove seal of claim 1, wherein the illumination sources include a plurality of infrared light transmitters and a plurality of visible light transmitters.

8. The pathway groove seal of claim 1, wherein the illumination sources are in communication with a remote power supply.

9. The pathway groove seal of claim 1, wherein the controller activates a selected group of the illumination sources under a predetermined set of conditions.

10. The pathway groove seal of claim 9, wherein the activated illumination sources transmit light to illuminate a portion of the pathway surface adjacent a groove emplaced pathway groove seal.

11. The pathway groove seal of claim 1, wherein the enclosure has a plurality of chambers within the enclosure and the illumination sources are positioned within one of the chambers.

12. A selectably illuminatable roadway groove seal for insertion into a roadway surface comprising:
a compressible, transparent elastomeric elongated enclosure having a first side and a second opposed side, wherein when the enclosure is emplaced in a groove in a roadway the first side of the enclosure sealingly abuts a first side of the groove and the second side of the enclosure sealingly abuts a second side of the groove;
a plurality of visible light sources positioned within the enclosure, wherein the light sources are positioned along the length of the enclosure and wherein the light sources are in communication with a remote power supply; and
a programmable controller in communication with the visible light sources, wherein the controller activates a first set of the light sources whenever a first set of conditions occur, whereby the activated light sources illuminate the roadway surface proximal to the activated light sources.

13. The selectably illuminatable roadway groove seal of claim 12, wherein the plurality of visible light sources include light sources that transmit more than one light color.

14. The selectably illuminatable roadway groove seal of claim 13, wherein the first set of light sources consist of light sources transmitting a single color of light.

15. The selectably illuminatable roadway groove seal of claim 12, wherein at least one of the light sources is attached to an interior surface of the enclosure.

16. The selectably illuminatable roadway groove seal of claim 12, wherein the enclosure incorporates a plurality of chambers.

17. The selectably illuminatable roadway groove seal of claim 16, wherein the light sources are positioned within an upper chamber facing the roadway surface.

18. The selectably illuminatable roadway groove seal of claim 12, further comprising a plurality of infrared transmitters.

19. The selectably illuminatable roadway groove seal of claim 18, wherein the programmable controller is in communication with the infrared transmitters and activates a set of the infrared transmitters upon the occurrence of a predetermined set of conditions.

20. The selectably illuminatable roadway groove seal of claim 12, wherein the light sources are LEDs or OLEDs.

21. A selectably illuminatable roadway groove seal for insertion into a roadway surface comprising:
an elastomeric elongated enclosure having a first side and a second opposed side, wherein when a length of the enclosure is emplaced in a groove formed in a roadway surface the first side of the enclosure sealingly abuts a first side of the groove and the second side of the enclosure sealingly abuts a second side of the groove; and
a plurality of infrared transmitters positioned within the enclosure, wherein the infrared transmitters illuminate a portion of the roadway surface;
whereby the portion of the roadway surface illuminated by the infrared transmitters is visualized by a vehicle equipped with an infrared sensor.

22. The roadway groove seal of claim 21, further comprising a plurality of visible light transmitters.

23. The roadway groove seal of claim 22, wherein the infrared transmitters and the visible light transmitters are in communication with a programmable controller and wherein the controller activates a first set of the infrared transmitters under a first set of conditions and activates a second set of the visible light transmitters under a second set of conditions.

24. The roadway groove seal of claim 21, wherein the infrared transmitters are in communication with a programmable controller.

25. The roadway groove seal of claim 24, wherein the controller activates a first set of the infrared transmitters under a first set of conditions and activates a second set of the infrared transmitters under a second set of conditions.

26. A method of illuminating the borders of roadway traffic lanes, the method comprising the steps of
(a) obtaining a groove seal having a compressible elastomeric elongated enclosure having a first side and a second opposed side and a selectable array of light sources positioned within the enclosure along a length of the enclosure;
(b) emplacing the groove seal in a roadway groove that runs parallel with a traffic lane of a roadway, wherein when the groove seal is emplaced in the roadway groove the first side of the groove seal enclosure sealingly abuts a first side of the roadway groove and the second side of the groove seal enclosure sealingly abuts a second side of the roadway groove;
(c) providing a power supply in communication with the light sources in the groove seal;
(d) providing a programmable controller in communication with the light sources and the power supply, wherein the controller activates a first set of the light sources whenever a first set of conditions occur,
whereby the activated light sources illuminate the roadway surface proximal to the activated light sources.

27. The method of claim 26, wherein the first set of light sources include a light source emitting visible light.

28. The method of claim 26, wherein the first set of light sources emit visible light of a single color.

29. The method of claim 26, wherein the first set of light sources include a light source emitting infrared light.

30. A method of transmitting information to a vehicle traveling along a roadway traffic lane, the method comprising the steps of:
(a) obtaining a groove seal having a compressible elastomeric elongated enclosure having a first side and a second opposed side and a selectable array of infrared light sources positioned within the enclosure along a length of the enclosure
(b) emplacing the groove seal in a roadway groove that runs parallel with a traffic lane of a roadway, wherein when the groove seal is emplaced in the roadway groove the first side of the groove seal enclosure sealingly abuts a first side of the roadway groove and the second side of the groove seal enclosure sealingly abuts a second side of the roadway groove;
(c) providing a power supply in communication with the infrared light sources in the groove seal; and
(d) providing a programmable controller in communication with the infrared light sources and the power supply, wherein the controller activates a first set of the infrared light sources to transmit an infrared transmission whenever a first set of conditions occur,
whereby the infrared transmission is communicated to an infrared sensor on a vehicle traveling along the roadway traffic lane.

31. The method of claim 31, wherein the groove seal further includes a selectable array of visible light sources in communication with the power supply and the controller.
